(19) United States
(12) Patent Application Publication
(10) Pub. No.: US 2005/0050318 A1
(43) Pub. Date: Mar. 3, 2005

(54) Profiled access to wireless LANs

(75) Inventors: Vijay B. Alone, Pune (IN); Junichi Asoh, Tokyo (JP); Sudham S. Rao, Sagamihara-shi (JP); Ratan Ray, Cary, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/898,634

(22) Filed: Jul. 23, 2004

(30) Foreign Application Priority Data
Jul. 30, 2003 (JP) 2003-283094

(51) Int. Cl. G06F 11/30; H04L 9/00

(52) U.S. Cl. 713/155; 380/270; 713/201

(57) ABSTRACT

A user PC reads security information regarding itself, and acquires a profile including security information in a profile acquisition/output unit, the profile being created in an administrator's PC administering the setting of an access point. The security information included in the profile and the read information are compared with each other, and when both coincide, a setting of wireless communications is performed by a communication setting unit by use of the profile. Furthermore, status of a validity period and the like, when the wireless communications are set by use of the profile, are monitored by a status monitoring processing unit. When it is judged necessary to update the profile based on the monitored status, a profile including an update request is created by a data update processing unit, and the created profile is sent out to the administrator's PC.

### BACKGROUND OF THE INVENTION

The present invention relates to a computer apparatus performing external communications, and the like, and more specifically, to a computer apparatus connectable to a wireless LAN, and the like.

A computer apparatus represented by a notebook type personal computer (notebook PC) is connectable to a network such as a local area network (LAN) by an interface instrument called as a network interface card (NIC), a LAN adapter or the like. As interfaces connected to the network, a dial-up modem has been used at an initial stage, and Token-Ring and Ethernet (registered trademark) are currently been used. Wired communications using such interfaces are currently a mainstream. However, in terms of avoiding inconvenience of cabling, and further, as mobile terminals such as the notebook PC, a cellular phone and a PDA are being developed rapidly, it is expected that wireless LANs will be ubiquitous in the future.

As described above, the rapid widespread of the wireless LAN is expected, and it becomes important to secure a security level achieved in the conventional wired LAN. Specifically, in the case of the wireless LAN, transmission data is broadcasted to the air by use of radio waves. Therefore, for any of client PCs located in a service area of an access point that is a transmission device, it is possible to receive the data. Accordingly, in the IEEE 802.11b standard, some systems regarding security are prepared.

For the security of such systems which are prepared according to the IEEE 802.11b, first, an SSID (Service Set Identifier) is given. The SSID is a common network name added to devices of a wireless LAN subsystem, and is used for logically dividing the subsystem. In this SSID, an arbitrary (up to 32 characters) code is set at clients and at least one access point. The access point can be configured to allow only clients, at which the same codes as that inherent in the access point are set, to communicate therewith. Moreover, as another system, MAC (Media Access Control) address filtering is provided. In this MAC address filtering, by registering MAC addresses of client instruments (cards) with the access point, accesses from instruments other than the instruments having the MAC addresses are filtered, thus making it possible to prevent an unauthorized invasion onto the access point. Furthermore, as still another system, WEP (Wired Equivalent Privacy) is provided. In this WEP, a wireless section is encrypted by use of an encryption key (of 40 bits or 128 bits) by a technology known as RC4, thus making it possible to prevent the unauthorized invasion from an instrument that does not have the same encryption key as that of the wireless section and to prevent an information leakage caused by interception of wireless packets by a third party.

However, in such an IEEE 802.11 b environment, some worries exist about the security. For example, the SSID is set such that each of the clients receives a broadcast signal including the SSID inherent therein from among beacons transmitted at a fixed interval. Accordingly, it is difficult to say that the SSID is one which is always secure. Moreover, in the MAC address filtering, the MAC addresses are entered manually, and there is an apprehension that “spoofing” occurs due to burglary and loss of the cards. Furthermore, in the WEP system, the access point and the group of clients share the shared key, and though it is not easy to decrypt the shared key, a need for stronger security is enhanced.

Accordingly, in order to resolve the worries about the security in the IEEE 802.11b environment, a construction technology of an IEEE 802.1x environment for securing higher security is studied. In this IEEE 802.1x environment, an authentication server such as a RADIUS (Remote Authentication Dial-In User Service) server is provided separately. In order to configure a wireless LAN connection under such an environment, it is necessary for users (clients) to establish authentication with the authentication server based on, for example, EAP (Extensible Authentication Protocol). This authentication server for use in the wireless LAN environment is a server for authenticating an access by using an encryption key in the WEP for each session and operating together with each client. By providing such an authentication server, it is made possible to accept logins from only users authenticated by user IDs and passwords. Consequently, the “spoofing” due to burglary and loss of hardware can be avoided, and a more reliable security measure can be taken. Moreover, a variety of security protocols such as LEAP (Light EAP) can also be adopted.

Note that, as a conventional technology described in a publication, the following one is present. In the technology, MAC address authentication is performed by extending a shared key authentication mode specified by IEEE 802.11, thus enabling the MAC address authentication for a large number of user stations. Moreover, safety is enhanced by providing a validity period for the shared key in the WEP. Furthermore, a MAC address table is dynamically updated according to an instruction from the authentication server, thus enabling the authentication by use of MAC address information until immediately before a failure of the authentication server (for example, refer to Patent Document 1).

Japanese Patent Laid-Open No. 2001-111544 (pp. 4-6, FIG. 2)

### SUMMARY OF THE INVENTION

As described above, as in the conventional technology and Patent Document 1, which are as described above, it is possible to enhance the security level by providing the authentication server. However, in many cases, the strengthening of the security by the authentication server is limited to, for example, an organization having sufficient resources such as a large enterprise. In a small-scale wireless network environment of, for example, a small-to-medium enterprise, a small-scale office, a law firm or the like, in some cases, it is difficult to locate such an authentication server because of a shortage of finances and a shortage of human resources. Even in such a small wireless network environment without the authentication server, it is desired to secure sufficient security.

Moreover, when a user control function by the authentication server is mounted on the wireless LAN system, it becomes necessary to register the user IDs and the passwords, which are not implemented in the wireless LAN instruments, every time when a new client is registered. This leads to a large load on a network administrator, and in the small-to-medium enterprise and the small-scale office, which are short of human resources, the registration of the user IDs and passwords cannot be performed appropriately, and therefore, the safety cannot be sufficiently secured.

The present invention is one created in order to solve such a technical problem as described above. It is an purpose of the present invention to reduce, to a great extent, the work required for setting data securely and so on in a wireless LAN, which is done by a network administrator.

It is another purpose of the present invention to prevent, by use of a simple configuration, a wireless LAN profile from being used by an unauthorized user under a wireless network environment.

It is still another purpose of the present invention to provide a wireless network environment, where safety is further enhanced, by setting update timing of the profile and a validity period thereof and so on.

It is yet another purpose of the present invention to provide an algorithm that does not require an intervention of a user in encrypting and decrypting the wireless LAN profile.

Moreover, it is another purpose of the present invention to enable, for example, the profile to be updated by an administrator PC for administering an access point.

On the basis of such purposes, the present invention is a computer apparatus capable of performing wireless communications through a predetermined access point. The computer apparatus acquires, from a computer apparatus of an administrator administering a setting of the access point, a profile created in the computer apparatus of the administrator and including security information for the wireless communications by a profile acquiring mechanism. In a condition judging mechanism, the profile acquired by the profile acquiring mechanism is deciphered, and it is judged whether or not the computer apparatus meets conditions designated by the computer apparatus of the administrator based on the deciphered profile. Then, when the condition judging mechanism judges that the computer apparatus meets the conditions, a setting of the wireless communications is performed by use of the profile in a setting mechanism. Here, the “profile” is a set of various kinds of setting information, and in the present invention, a “wireless LAN profile” that is a set of various kinds of setting information for the wireless LAN is simply referred to as the “profile.” The same can be said in the following description.

Moreover, an update request outputting mechanism outputs an update request for the profile acquired by the profile acquiring mechanism to the computer apparatus of the administrator. Here, suppose the computer apparatus is characterized in that the profile acquiring mechanism acquires a profile including validity period information, and that the update request outputting mechanism outputs the update request for the profile based on the validity period information included in the profile acquired by the profile acquiring mechanism. Then, for example, the safety under the wireless LAN environment can be further enhanced, as well as the work done by the network administrator can be reduced to a great extent.

Furthermore, the condition judging mechanism can judge that the computer apparatus is an apparatus meeting the conditions when identification information inherent in the computer apparatus and identification information included in the profile coincide with each other as a result of a comparison. Moreover, it is possible that the identification information judged by the condition judging mechanism can be a machine serial number of the computer apparatus and/or a MAC address of the computer apparatus. Still further, the condition judging mechanism can acquire identification information of the access point by scanning the access point, and can judge that the computer apparatus meets the designated conditions when the acquired identification information and identification information included in the profile coincide with each other as a result of a comparison.

Grasped from another viewpoint, a user's computer apparatus to which the present invention is applied includes a information reading mechanism for reading information regarding security of itself from a predetermined storage medium (memory). Moreover, in a profile acquiring mechanism, the user's computer apparatus acquires, from a computer apparatus of an administrator administering a setting of the access point, a profile created in the computer apparatus of the administrator and including security information for the wireless communications. Then, the user's computer apparatus compares the security information included in the profile acquired by the profile acquiring mechanism and the information read by the information reading mechanism with each other, and performs a setting of the wireless communications by a setting mechanism by use of the profile when the security information and the read information coincide with each other. Furthermore, by a status monitoring mechanism, the user's computer apparatus monitors a status when the wireless communications are set by use of the profile including a valid data and the like. By an update request outputting mechanism, the user's computer apparatus outputs an update request for the profile to the computer apparatus of the administrator when it is judged that it is necessary to update the profile based on the status monitored by the status monitoring mechanism. Here, the user's computer apparatus can be characterized in that the update request outputting mechanism encrypts a profile including date and time information, and outputs the encrypted profile to the computer apparatus of the administrator.

Meanwhile, the present invention is a computer apparatus for administering a setting of an access point under a wireless LAN environment. The computer apparatus comprises: a profile acquiring mechanism for acquiring a profile requested to be updated from a user's computer apparatus performing wireless communications with the computer apparatus under the wireless LAN environment; an update processor for performing update processing for the profile acquired from the profile acquiring mechanism; and an outputting mechanism for outputting, to the user's computer apparatus, a new profile formed through the update processing by the update processor. More specifically, the computer apparatus can be characterized in that the update processor performs the update by creating a new profile including at least any one of information of a new encryption key, information of a validity period, and information of an access point for which an access of the user's computer apparatus is authorized.

Furthermore, a wireless LAN system, to which the present invention is applied, comprises: an access point that is a connecting point of a network under a wireless LAN environment; a computer apparatus of an administrator administering a setting of the access point; and a user's computer apparatus for executing wireless LAN communications through the access point. The user's computer apparatus sends out information inherent therein to the computer apparatus of the administrator, and the computer apparatus of the administrator encrypts a profile for executing the wireless LAN communications based on the received inherent information, and sends out the encrypted profile to the user's computer apparatus. Then, the wireless LAN system can be characterized in that the user's computer apparatus decrypts the received profile, and performs a setting of the wireless LAN communications by use of the profile.

Here, suppose the wireless LAN system is characterized in that the user's computer apparatus judges, based on the decrypted profile, whether or not the user's computer apparatus itself meets conditions designated by the computer apparatus of the administrator, and performs the setting of the wireless LAN communications when judging that the user's computer apparatus meets the conditions. Then, this system is preferable because the safety of the network can be further enhanced. Moreover, suppose the wireless LAN system is characterized in that the user's computer apparatus forms the profile by including information regarding date and time in information of an encryption key for use in the user's computer apparatus, the information of the encryption key serving as the inherent information, encrypts the profile by use of the encryption key, and sends out the encrypted profile. Then, it is made possible to utilize the information regarding date and time as the information regarding the update request. Furthermore, suppose the wireless LAN system is characterized in that the user's computer apparatus forms the profile by including information regarding date and time in identification information of the device, the identification information serving as the inherent information, encrypts the profile by a hidden key, and sends out the encrypted profile. Then, even if the user's computer does not have an encryption key of its own, the user's computer can request for acquisition of a new profile.

Moreover, the present invention can be grasped as a method for updating a profile including setting information for allowing a computer apparatus to perform wireless LAN communications. The method for updating a profile, comprises the steps of: reading a profile including security information of the computer apparatus from a predetermined storage medium; creating a profile for an update request by including, in the profile, information regarding an update request for the profile including information of an encryption key for use and information regarding date and time; encrypting the profile for the update request by use of the read security information; and sending out the encrypted profile for the update request to a computer apparatus of an administrator.

Grasped from another viewpoint, the present invention is a method for acquiring a profile including setting information for allowing a computer apparatus to perform wireless LAN communications. The method comprises the steps of: reading identification information inherent in the computer apparatus from a predetermined storage medium; creating a profile including information regarding an acquisition request for a new profile together with the identification information; encrypting the created profile by use of a hidden encryption key; and sending out the encrypted profile to a computer apparatus of an administrator. Here, the method can be characterized in that the step of creating a profile creates the profile by including information to the effect that the profile does not have an encryption key inherent in the computer apparatus and information regarding date and time when the profile is sent out.

Note that the present invention can be grasped as a program configured to allow a user's computer apparatus performing communications by connecting to a predetermined wireless network to realize these respective functions, or a program configured to allow a computer apparatus of an administrator administering an access point to realize the respective functions. In the case of providing each program to each computer apparatus, for example, besides the case of providing the program in a state of being installed in a notebook PC, conceivable is a mode of providing the program to be executed by the computer apparatus in a storage medium storing the program so as to be readable by the same computer apparatus. As such a storage medium, for example, DVD and CD-ROM media and the like are applicable. The program is read by DVD and CD-ROM readers and the like, then stored in a flash ROM and the like, and thus executed. Moreover, there is a mode where these programs are provided through a network by, for example, a program transmitter.

Specifically, a program to which the present invention is applied allows a user's computer performing wireless LAN communications to realize: a function to read information regarding security of the user's computer apparatus from a predetermined storage medium; a function to acquire a profile including security information for the wireless LAN communications from a computer apparatus of an administrator administering a setting of an access point in the wireless LAN communications, the profile being created in the computer apparatus of the administrator; and a function to compare the security information included in the acquired profile with the information read from the storage medium, and to perform a setting of the wireless LAN communications by use of the profile when both of the information coincide with each other. The program can be characterized by allowing the computer apparatus to further realize: a function to monitor a status of the profile; a function to judge whether or not it is necessary to update the profile based on the monitored status; and a function to output an update request for the profile to the computer apparatus of the administrator when it is necessary to update the profile. Here, the program can be characterized in that the function to output an update request for the profile to the computer apparatus of the administrator encrypts the profile including information regarding the update request based on the information read from the storage medium, and outputs the encrypted profile.

Moreover, a program to which the present invention is applied allows a computer apparatus administering a setting of an access point under a wireless LAN environment to realize: a function to acquire a profile requested to be updated from a user's computer apparatus performing wireless communications with the computer apparatus under the wireless LAN environment; a function to judge whether or not update processing is necessary for the acquired profile; a function to create a new profile when the update processing is judged necessary; and a function to encrypt and output the created new profile. Here, the program is characterized in that the created new profile includes at least any one of information of a new encryption key, information of a validity period, and information of an access point for which an access of the user's computer apparatus is authorized.

According to the present invention, for example, the work for securing the safety, which is done by the network administrator, can be reduced to a great extent.

### BRIEF DESCRIPTION OF THE DRAWINGS

Some of the purposes of the invention having been stated, others will appear as the description proceeds, when taken in connection with the accompanying drawings, in which:

FIG. 1 is a view showing a system configuration of a wireless LAN, to which this embodiment is applied;

FIG. 2 is a block diagram for explaining each hardware configuration of an administrator PC and user PCs, to which this embodiment is applied;

FIG. 3 is a view for explaining a processing function in the administrator PC;

FIG. 4 is a view for explaining a processing function in each user PC.

FIGS. 5(a) to 5(d) are views for explaining a creation method of an encrypted packet sent out to the administrator PC, as processing executed in the user PC;

FIGS. 6(a) to 6(c) are views for explaining processing for decrypting a packet received in the administrator PC and processing for creating a new encrypted packet, which are executed in an administrator's application of the administrator PC;

FIG. 7 is a flowchart showing processing for capturing a profile, which is executed in the user PC;

FIG. 8 is a flowchart showing processing for verifying the profile, which is executed in the user PC;

FIG. 9 is a flowchart showing processing for issuing an update request for the profile to the administrator PC;

FIG. 10 is a flowchart showing processing executed in the administrator PC; and

FIG. 11 is an illustration showing an example of a user interface displayed on a display of the administrator PC.

### DETAILED DESCRIPTION of the ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

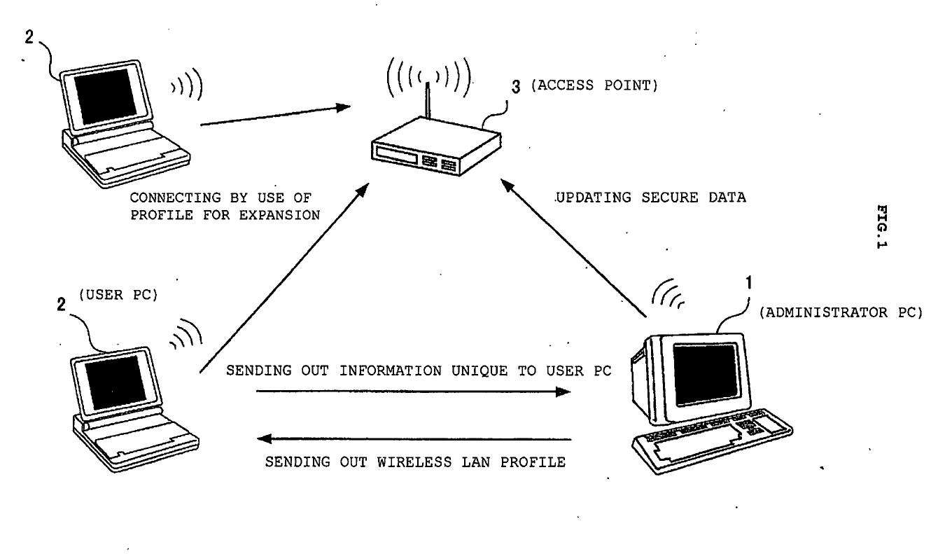

Referring now more particularly to the accompanying drawings, in which like numerals indicate like elements or steps throughout the several views, FIG. 1 is a view showing a system configuration of a wireless LAN, to which this embodiment is applied. Here, the system includes an administrator PC 1 that is a PC (personal computer) of an administrator administering a network of the wireless LAN, user PCs 2 that are client PCs utilizing the wireless LAN, and an access point 3 that is a connection point prepared for the users by a service provider of the network. This embodiment has a feature that an authentication server is not required though a highly safe wireless LAN environment is provided.

For the access point 3, the administrator PC 1 updates secure data therefor, which is for security control. In the case of realizing the wireless LAN environment in this embodiment, first, the user PCs 2 send out machine (device)-unique information thereof, for example, through a wired network such as Ethernet or a predetermined wireless network. In the case of authorizing the user PCs 2 to use the wireless network of this embodiment, the administrator PC 1 that has received the machine-unique information creates data of a key of the access point 3, and sends out, to the user PCs 2, the data as an encrypted wireless LAN profile (hereinafter, simply referred to as a “profile” in some cases). Here, the “profile” is a set of various kinds of setting information, and as the information of the “wireless LAN profile,” a hidden WEP key and a WPA PSK (WiFi Protected Access Pre-shared Key) are given. The sending out of the profile is implemented through the wired network before the use of the wireless LAN is started, and at an updating time after the user PCs 2 start the use of the wireless LAN, the administrator PC 1 can send out the profile, for example, through the access point 3 to the wireless LAN. Note that a method for sending out the profile is not particularly limited. The user PCs 2 that have received the wireless LAN profile start to connect with the access point 3 by use of a profile for expansion.

Next, each configuration of the administrator PC 1 and user PCs 2 will be described.

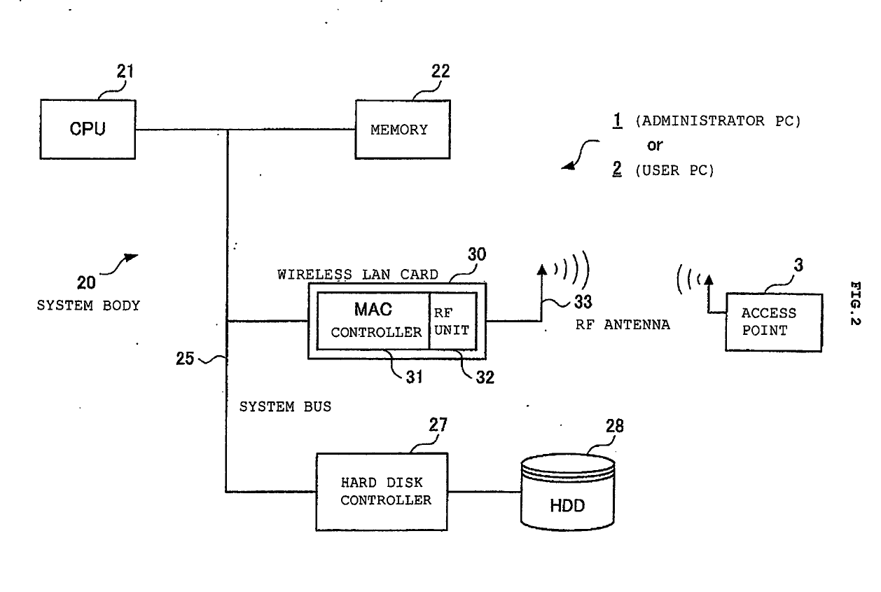

FIG. 2 is a block diagram for explaining each hardware configuration of the administrator PC 1 and user PCs 2, to which this embodiment is applied. The administrator PC 1 and the user PCs 2 can realize the respective functions by a similar hardware configuration. Here, for the purpose of facilitating the understanding of the invention, a hardware configuration for use in constructing a network system of the wireless LAN is definitely shown. A general hardware configuration of each of the above PCs for realizing a computer apparatus is similar to the other ones. The administrator PC 1 can be composed of a desktop type PC or a notebook PC. In order to install a wireless LAN function, not only a wireless LAN card is inserted into each PC, but also a wireless LAN board is provided in a case of a system body of each PC in some cases. Each user PC 2 is a computer apparatus as a mobile terminal in many cases, and for example, is composed of a notebook PC, a PDA, a cellular phone or the like.

FIG. 2 shows an example where the administrator PC 1 or each user PC 2 is made to function as a wireless terminal by connecting a wireless LAN card 30 to a system body 20 thereof. The system body 20 includes a CPU 21, which functions as a brain of the entire computer apparatus, and executes a variety of programs such as utility programs under control of an OS. Moreover, the system body 20 includes a memory 22 that is a main memory, which supplies a variety of programs (commands) including application programs to the CPU 21, and plays a role such as a primary memory for data. This CPU 21 is interconnected to the respective peripheral devices through a system bus 25 such as, for example, a PCI (Peripheral Component Interconnect) bus. In this embodiment, inherent information of the user PC 2, which is present therein, is dynamically created by a program on the memory 22 that is a storage medium. More specifically, the information is read out of the program through an API (Application Program Interface) or the like provided by the OS. It is possible to read the dynamically created inherent information from the memory 22 that is the storage medium.

The system body 20 includes, as a peripheral device, a hard disk drive (HDD) 28 that is a storage medium in which various programs, data and the like are stored. Then, a hard disk controller 27 for controlling this hard disk drive 28 is connected to the system bus 25. Moreover, for example, unillustrated mini PCI slot and PC card slot are connected to the system bus 25. The system body 20 is configured such that, for example, the wireless LAN card 30 in conformity with the mini PCI standard and the like is attachable (connectable) to any of these slots. In the case of utilizing the system body for the user PC 2, in this embodiment, when security information in a profile acquired from the administrator PC 1 and the inherent information of the user PC 2, which is read from the memory 22, coincide with each other, a profile is stored in the hard disk drive 28, disk drive 28 being one of the storage media. Specifically, as a result, setting information regarding the wireless LAN is stored in this hard disk drive 28.

In the wireless LAN card 30, an RF antenna 33 performing wireless communications with the access point 3 under an environment where the notebook PC or the like is placed or is provided integrally therewith. Note that, besides this case of being provided integrally with the wireless LAN card 30, for example, it is also possible to compose the RF antenna 33 such that an RF (radio frequency) signal is propagated thereto from an antenna connector through a coaxial cable. Alternatively, it is also possible to compose the RF antenna 33 as, for example, a diversity antenna provided inside a case of the notebook PC so as to perform wireless communications with the access point 3.

The wireless LAN card 30 includes a MAC controller 31 having an interface with the CPU 21 in a MAC (Media Access Control) layer that is an underlying sublayer in data link layer protocol, and an RF unit (high-frequency circuit unit for wireless communications) 32 supporting a wireless LAN in 2.4 GHz band in the international standard IEEE 802.11b or in 5 GHz in the international standard IEEE 802.11a. These MAC controller 31 and RF unit 32 enable the system body 20 connected to the wireless LAN card 30 to communicate with the access point 3 through the RF antenna 33 under control of the CPU 21.

This embodiment proposes, in such a system configuration as shown in FIG. 2, a software technique for safely setting an encryption key (hereinafter, simply referred to as a “key” in some cases) in a PC such as the administrator PC 1 and the user PCs 2 and for updating the encryption key periodically and safely. In this case, the encryption key is WEP, WPA-PSK or the like utilized when each PC connects with the access point 3 by use of the wireless LAN card 30. When the administrator PC 1 and the user PCs 2 communicate with the access point 3, such a predetermined encryption key as described above is utilized, and for example, the encryption key is read out of the hard disk drive 28 and processed by software on the memory 22. Moreover, in the case of transmitting/receiving data, this encryption key serves as a master key for creating encrypted data in the inside of the wireless LAN card 30 conformed with the 802.11. This master key is updated periodically according to needs, and thus an unauthorized access to the access point 3 by a third party and an invasion to the network by the third party are prevented.

Next, a content of the software realized by this embodiment will be described. Those of skill in the art will recognize that the software described in this embodiment, as in other embodiments, can be implemented as logic in hardware or in firmware in combination with a micro-controller or other hardware/software components.

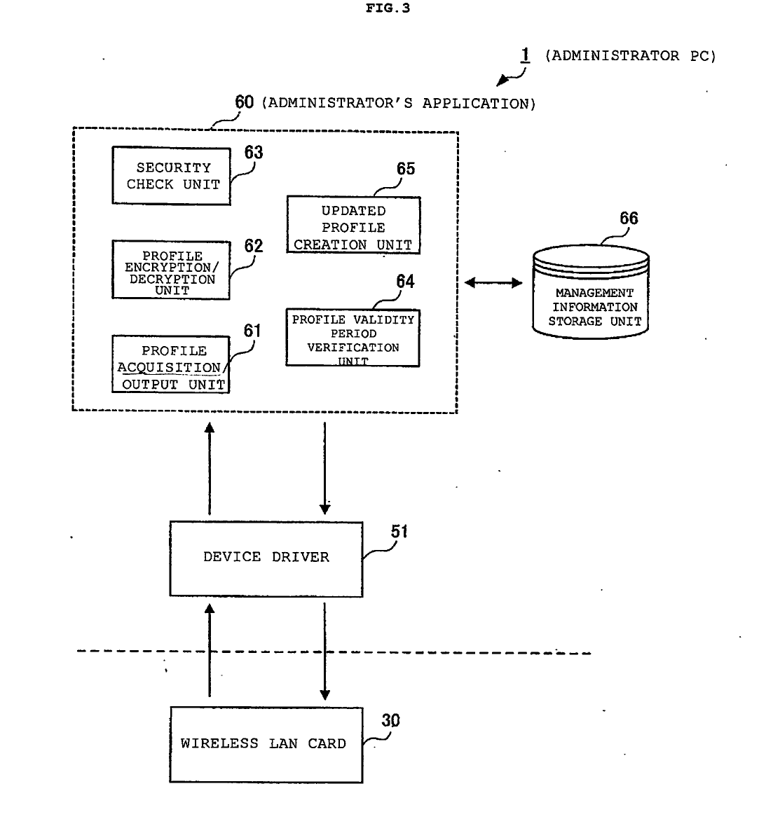

FIG. 3 is a view for explaining a processing function in the administrator PC 1. Here, provided are a device driver 51 that is software for administering the device (wireless LAN card 30), a management information storage unit 66 for storing various kinds of information of the user PCs 2, which are included in the network system of the wireless LAN, by use of, for example, the hard disk drive 28 as a hardware resource, and an administrator's application 60 for executing creation of update data of a wireless LAN profile requested to be updated. This application 60 is an application program executed by the CPU 21.

The administrator's application 60 includes a profile acquisition/output unit 61 for acquiring an encrypted packet (profile) from each user PC 2 and outputting a packet (profile) encrypted by the profile acquisition/output unit 61 itself, and a profile encryption/decryption unit 62 for encrypting and decrypting the profile. Moreover, the administrator's application 60 includes a security check unit 63 for performing a security check for the acquired profile, a profile validity period verification unit 64 for verifying a validity period of the acquired profile, and an updated profile creation unit 65 for creating new profile data.

In the administrator PC 1, in the profile acquisition/output unit 61, a profile including an update request is acquired from the user PC 2. In the profile encryption/decryption unit 62, the acquired profile is decrypted by use of the encryption key stored in the management information storage unit 66. The decrypted profile is subjected to a security check in the security check unit 63, and a validity period thereof is verified in the profile validity period verification unit 64. Thereafter, when it is necessary to update the data, an updated profile is created in the updated profile creation unit 65, and is encrypted in the profile encryption/decryption unit 62. Thereafter, the encrypted profile passes through the profile acquisition/output unit 61 and the device driver 51, and then returned to the user PC 2 by use of the wireless LAN card 30. Moreover, a content of the created updated profile is stored in the management information storage unit 66.

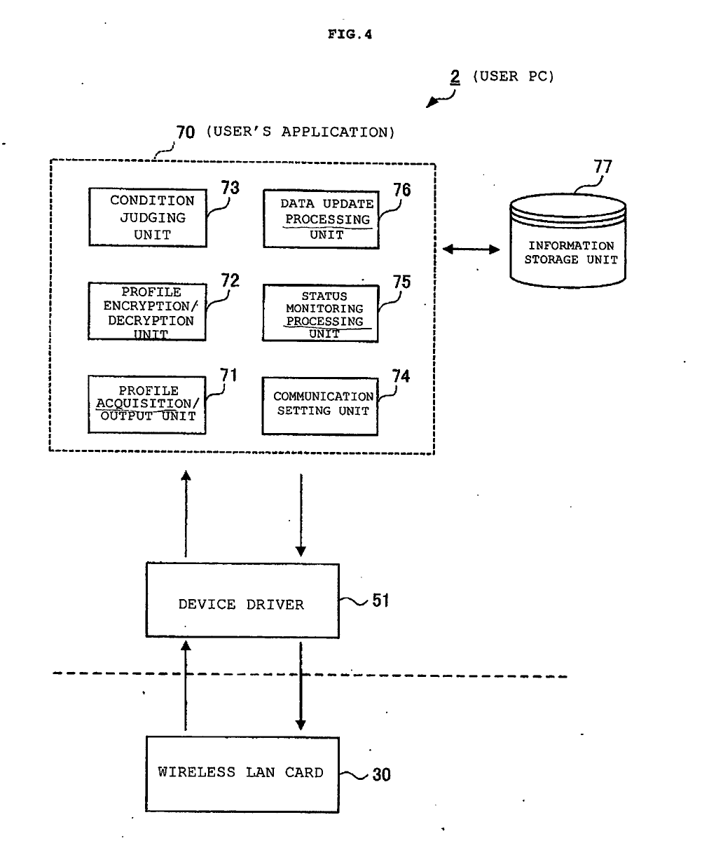

FIG. 4 is a view for explaining a processing function in the user PC 2. Here, similarly to the administrator PC 1, a device driver 51 that is software for administering the wireless LAN card 30 that is a device is provided. Moreover, there is provided an information storage unit 77 for storing various kinds of information of the user PC 2 regarding the wireless LAN profile and the like by use of, as a hardware resource, for example, the hard disk drive 28 that is one of the storage media. Furthermore, a user's application 70 is provided as an application program executed in the CPU 21.

This user's application 70 includes a profile acquisition/output unit 71 for acquiring an encrypted packet (profile) from the administrator PC 1 and outputting a packet (profile) encrypted by the profile acquisition/output unit 71 itself, and a profile encryption/decryption unit 72 for encrypting and decrypting the profile. Moreover, the user's application 70 includes a condition judging unit 73 for judging whether or not the user PC 2 meets conditions included in the acquired profile and designated by the administrator PC 1, and a communication setting unit 74 for making a connection to the access point 3 by use of this acquired file when the condition judging unit 73 judges that the conditions are met. Furthermore, the user's application 70 includes a status monitoring processing unit 75 for monitoring application situation and status of the profile being used, and a data update processing unit 76 for capturing the profile in the user PC 2 and updating the profile data stored in the information storage unit 77.

Specifically, this data update processing unit 76 performs processing for capturing the profile including security information (WEP, WPA-PSK and the like) of the wireless LAN, which is created in the administrator PC 1 administering the setting of the access point 3, into the user PC 2 utilizing the profile. In this case, in the user's application 70, the profile passed from the administrator PC 1 and then encrypted is decrypted in the profile encryption/decryption unit 72 in order that only a PC designated by the administrator PC 1 can operate. Then, the condition judging unit 73 tests, based on the decrypted profile, whether or not the user PC 2 is a PC meeting the conditions designated by the administrator PC 1, for example, by reading out identification information inherent therein. Then, only when validity is present, wireless communications are set by the communication setting unit 74 by use of the profile.

The status monitoring processing unit 75 monitors whether or not such a status, where the wireless LAN profile currently being utilized by the user PC 2 will expire ocurs. When the status such as the expiration of the profile is detected by this status monitoring processing unit 75, the data update processing unit 76 captures the security data (WEP key, password information of WPA-PSK and the like) of the wireless LAN from the information storage unit 77 of the user PC 2 currently utilizing the wireless LAN profile. Then, the data update processing unit 76 creates a profile including information that indicates a date of sending out the profile as information requesting the update. The created profile is encrypted by the profile encryption/decryption unit 72, and then passed to the administrator PC 1 through the profile acquisition/output unit 71.

Meanwhile, the communication setting unit 74 passes, to the device driver 51 of the wireless LAN, setting information in the wireless LAN profile acquired from the administrator PC 1 and tested in validity by use of the same profile. Then, the communication setting unit 74 makes the connection to the access point 3. In this case, the status monitoring processing unit 75 tests whether or not the connection is limited only to the specific access point 3 designated by the profile, verifies the validity period of the profile, and so on. Moreover, the user PC 2 receives the WEP key and the like updated by the administrator PC 1 in the profile acquisition/output unit 71. Then, the WEP key and the like undergo the decryption by the profile encryption/decryption unit 72 and the determination by the condition judging unit 73, and it is judged whether or not the profile is valid. When the profile is valid, the communication setting unit 74 sets various conditions by use of the information of the profile, thus enabling the connection to the access point 3, which uses the wireless LAN card 30.

Next, a creation flow of the wireless LAN profile will be described.

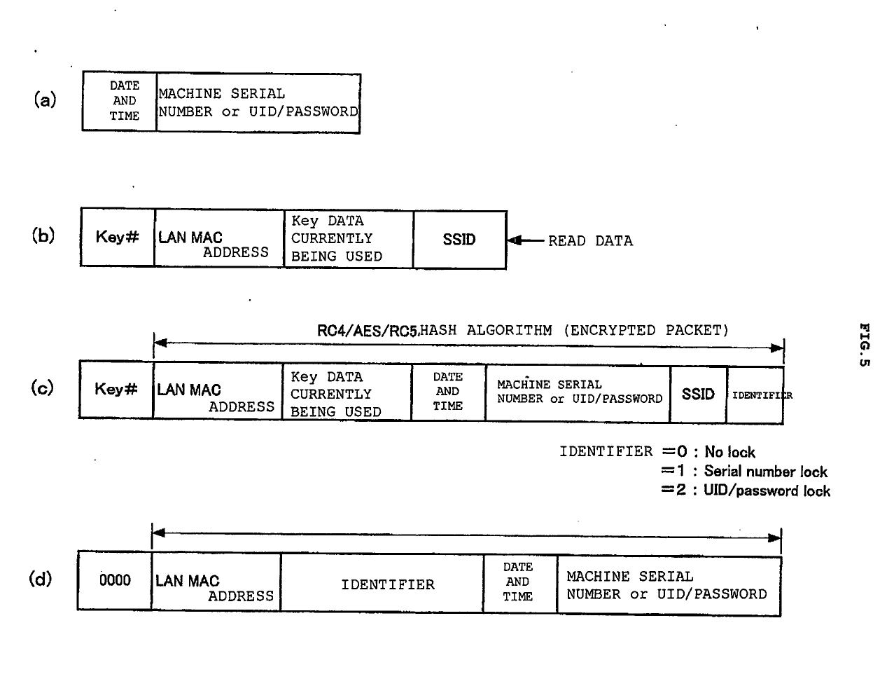

FIGS. 5(a) to 5(d) are views for explaining a creation method of the encrypted packet sent out to the administrator PC 1, as processing executed in the user PC 2. In FIG. 5(a), date and time information, and a machine serial number from the information storage unit 77, are captured by the user's application 70 of the user PC 2. Moreover, when the user is a user of a hotspot where the wireless LAN is usable, inputted user ID, password and the like of the wireless LAN are captured as the inherent information of the user PC 2.

When a predetermined key is currently used, as shown in FIG. 5(b), a key number (Key#) for utilizing the WEP, a MAC address of the network, information of a valid encryption key currently being used (for example, an encryption key of 128 bits), a network name (SSID: Service Set Identifier) of the access point 3, are read. Thereafter, as shown in FIG. 5(c), contents of the packets shown in FIGS. 5(a) and 5(b) are encrypted by use of a combination of the encryption key of the WEP or WPA-PSK currently being used and a hidden key as a hash key. As hash algorithms for creating the encrypted packet, for example, RC4 (trademark) and RC5 (trademark) of RSA Data Security, Inc. in the United States, AES (Advanced Encryption Standard), and the like, are given. As described above, by use of the packet formed by encrypting the profile, the key number (Key#), the MAC address, the information of the key being used, the date and time, the machine serial number, the SSID, and an identifier, are transmitted to the administrator PC 1 from the user PC 2.

FIG. 5(d) shows an example of a packet created in the user PC 2 in the case where the encryption key is not present, as in the case of performing the wireless LAN communication for the first time. Here, “0000” is set in a section for the key number (Key#), which is shown in FIG. 5(c). Moreover, the MAC address, the UID, a current date and time, and the machine serial number, are included, as well as the user ID/password in the case of the hotspot. These pieces of data are encrypted by use of the key prepared in the system in advance, and then sent out. Note that, for example, the identifiers represent the following information: 0 for “No lock”; 1 for “Serial number lock”; and 2 for “UID/password lock.”

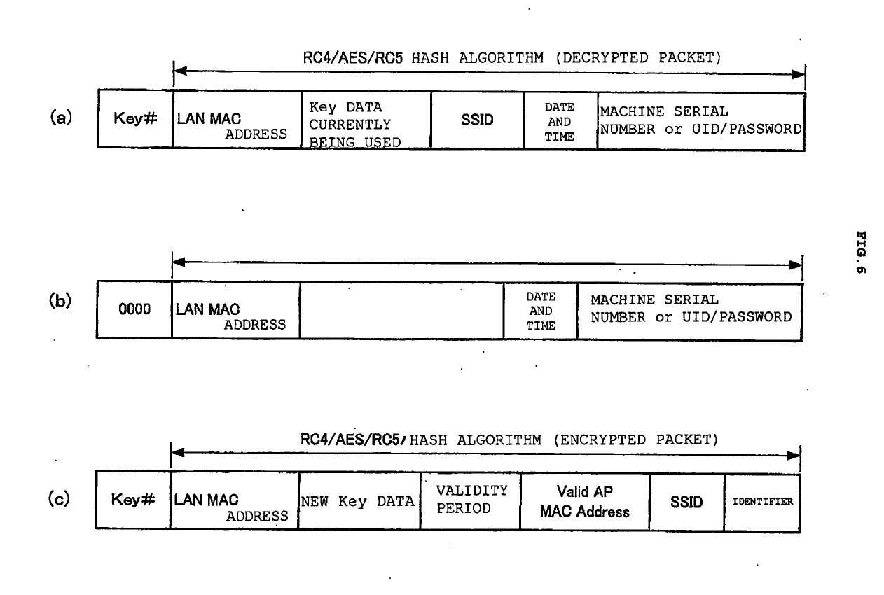

FIGS. 6(a) to 6(c) are views for explaining processing for decrypting the packet received in the administrator PC 1 and processing for creating a new encrypted packet, which are executed in the administrator's application 60 of the administrator PC 1. First, as shown in FIG. 6(a), a key currently being used is designated when the key number is other than 0. For example, information of an encryption key (WEP key) is read out from the management information storage unit 66 shown in FIG. 3 by use of the key number. This encryption key of the wireless LAN is one knowable only by the user PC 2 that has sent out the profile and the administrator PC 1. A profile including the encryption key is decrypted in the administrator PC 1 without being decrypted by the other person. In the administrator's application 60, the profile is decrypted by use of the read encryption key, and as shown in FIG. 6(a), a content of the information is deciphered. As this content of the information, a MAC address, information of the encryption key being used, an SSID, date and time, a machine serial number, user ID/password, and the like, are included.

Meanwhile, when the key number is “0000,” it is judged that this is the first time that a request for the profile comes in, and the packet is decrypted by use of a hidden encryption key known in advance by the system of the administrator PC 1, thus making it possible to decipher the content of the information as shown in FIG. 6(b). This content of the information includes the MAC address, the date and time, the machine serial number, the user ID/password, and the like.

Thereafter, in the administrator's application 60, a security check for the user PC 2 that has sent out the packet is executed based on the deciphered MAC address, machine serial number, user ID and the like. When it is judged that there is no problem as a result of the security check, update processing for the profile is executed. Moreover, a validity period of the profile data is set. In the update processing, information of a new WEP key to be used, a new MAC address, a new machine serial number, and the like, are set. These pieces of data are stored in the management information storage unit 66. When security data of the hotspot is updated, the current user ID is checked.

FIG. 6(c) is a view showing an example of an updated packet of the profile sent out from the administrator PC 1 to the user PC 2. As shown in FIG. 6(c), besides the key number, this packet includes the MAC address, information of a new encryption key, the SSID, the user ID, and the like. Moreover, the packet can include a validity period, the MAC address of the access point 3 for which an access of the user PC 2 is authorized, and the like. These respective pieces of information such as the MAC address, the information of the new encryption key and the valid data are encrypted by use of, for example, a hash key (a combination of the serial number of the user PC 2 and the hidden key, and so on), and then sent out to the user PC 2. The user PC 2 that has not had the key yet is enabled to make a communication by use of this key included in the updated packet thereafter.

Thereafter, in the user's application 70, the user PC 2 that has received such an updated packet uses the local machine serial number of its own, the inputted user ID/password when the user is a user of the hotspot, and the like, and decrypts the same updated packet by use of the key only knowable by itself. Thus, the updated packet is deciphered. A result of this decipherment is stored in the information storage unit 77 and used for a subsequent wireless LAN communication. In the case where the profile is used in an environment where the MAC address, the serial number, the user ID/password and the like are different (that is, where the environment is not a registered environment) when the updated profile is actually read out and used, for example, the status monitoring processing unit 75 invalidates these pieces of information without using the same. As this case where the updated profile is used in a different environment (that is, where the environment is not a registered environment), for example, the case where the profile is passed to the other person, the case where the profile is deciphered by accident, and the like, are taken as examples.

Moreover, in the case of making the connection to the network, if there are limitations from a validity period of the network and the MAC address of the access point in the profile, the wireless LAN communication is authorized within a range of these limitations. When the profile expires, the use of the profile is limited thereafter. Furthermore, in the case of making another communication before the profile expires, the user PC 2 issues an update request for the profile to the administrator PC 1 at, for example, a set day (X day) such as one week before the valid data, and updates the profile data according to such an algorithm as described above.

Next, description will be made for an example of processing for the case of allowing only the user PC 2 to utilize the wireless LAN in a limited area during a limited validity period, for example, when the user having the user PC 2 visits a predetermined office. Here, only the limited user PC 2 is authorized to use the wireless LAN, and the profile data is inhibited from being copied.

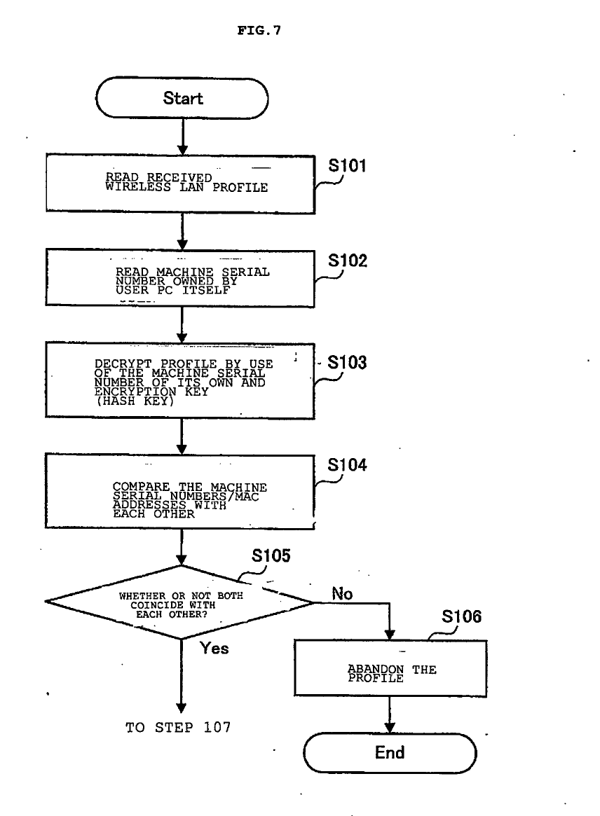

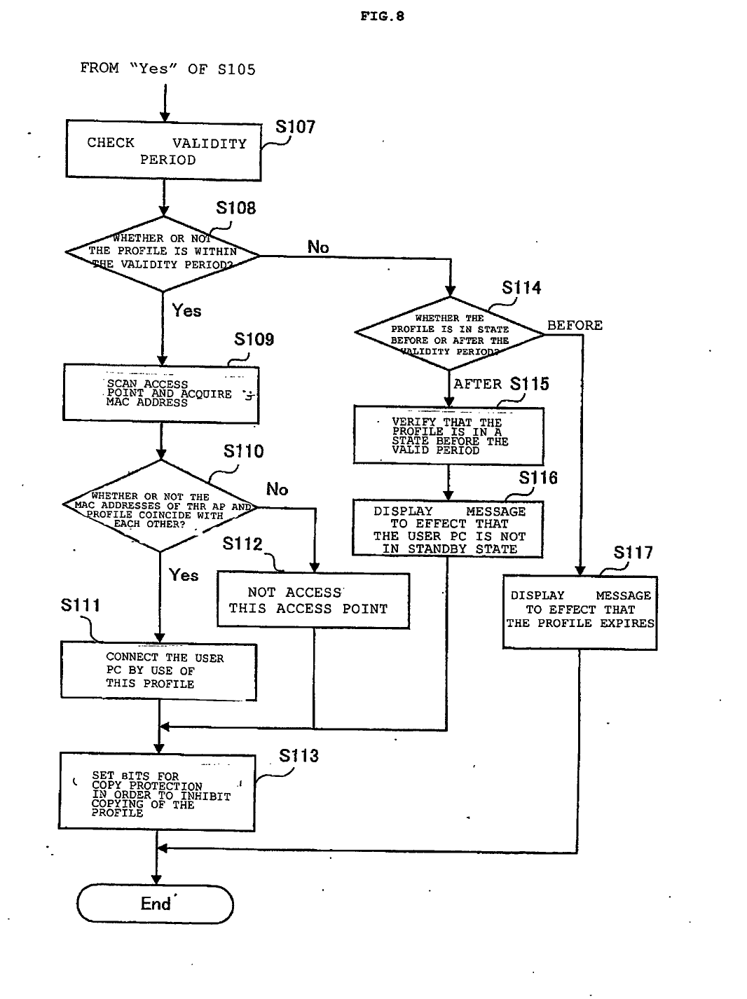

FIGS. 7 and 8 are flowcharts showing processing for capturing the profile and processing for verifying the profile, which are executed in the user PC 2. Here, as a prerequisite of the above, a flow of processing in the user PC 2 after the wireless LAN profile (profile) is transmitted from the administrator PC 1 to the user PC 2 is shown.

In the processing for capturing the profile, which is shown in FIG. 7, in the user's application 70 of the user PC 2, first, the wireless LAN profile (profile) received from the administrator PC 1 is read (Step 101). Then, a current machine serial number of the user PC 2 is read from the information storage unit 77 (Step 102). Thereafter, the read profile is decrypted by use of the read machine serial number of the user PC 2 and the encryption key (hash key) (Step 103). Then, the decrypted machine serial number/MAC address is compared with the serial number/MAC address actually read by the program and owned by the user PC 2 itself (Steps 104 and 105). When a result of this comparison shows a coincidence of the both, the processing moves to Step 107 shown in FIG. 8. When both of the machine serial numbers/MAC addresses do not coincide with each other in Step 105, the acquired profile is judged invalid, and then abandoned (Step 106). Then, the processing ends.

Next, the processing for verifying the profile, which is shown in FIG. 8, is executed. Specifically, when the machine serial numbers/MAC addresses of the pair coincide with each other in Step 105 of FIG. 7, in the user's application 70, it is checked whether or not the profile is within the validity period (Steps 107 and 108). When the profile is within the validity period, the access point 3 is scanned, and the MAC address of the access point is acquired (Step 109). Here, it is judged whether or not the acquired MAC address of the access point (AP) 3 and the MAC address received from the administrator PC 1 and included in the profile coincide with each other (Step 110). When both of the MAC addresses coincide with each other, the sent profile is judged valid, and by use of this profile, the user PC 2 is connected to the wireless LAN (Step 111). Thereafter, in order to inhibit the profile from being copied, bits for copy protection are set (Step 113), and the processing ends. When both of the MAC addresses do not coincide with each other in Step 110, an access is not made to this access point 3 (Step 112), the copy protection for the profile in Step 113 is implemented, and the processing ends.

Meanwhile, when the profile is not within the validity period in Step 108, it is judged whether the profile is in a state before or after the validity period (Step 114). When the profile is in a state before entering the validity period, this state is verified (Step 115). Then, a message to the effect that the user PC 2 is not in a standby state is displayed on a display (not shown) of the user PC 2, the copy protection for the profile in Step 113 is implemented, and the processing ends. When the profile is in a state after the end of the validity period, a message to the effect that the profile expires is displayed (S117), and the processing ends.

Next, processing of the user PC 2, which is performed when the profile nearly expires, will be described.

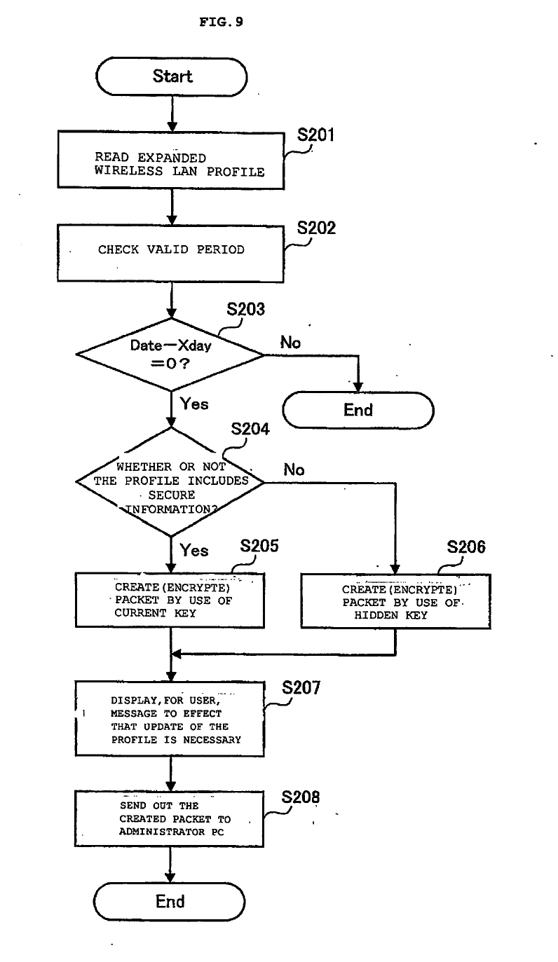

FIG. 9 is a flowchart showing processing for issuing an update request for the profile to the administrator PC 1 when the profile nearly expires. The status monitoring processing unit 75 of the user's application 70 in the user PC 2 reads the wireless LAN profile (profile), for example, stored in the information storage unit 77 and then expanded (Step 201), and checks the validity period (Step 202). In this case, it is judged whether or not the day reaches the X day (for example, one week before the end of the validity period and so on), and specifically, whether or not the profile nearly expires (Step 203). When the profile does not nearly expire, it is judged that the update is unnecessary, and the processing of FIG. 9 ends.

When the condition of Step 203 is satisfied and the profile nearly expires, the update request for the wireless LAN profile (profile) is sent out to the administrator PC 1. For this purpose, in the data update processing unit 76 of the user's application 70, it is first judged whether or not the profile read out from the information storage unit 77 includes a secure key (information), for example, whether or not the profile includes a highly confidential key such as the WEP key for the connection (Step 204). When the profile includes such a highly secure key, a packet is created (encrypted) by use of the key (Step 205), and the processing moves to Step 207. When the profile does not include the highly secure key in Step 204 (for example, when the key number is 0), a hidden key of the system is read out, for example, from the information storage unit 77, and a packet is crated (encrypted) by use of the hidden key (Step 206), and the processing moves to Step 207. In Step 207, information to the effect that the update of the profile is necessary is displayed on the display (not shown) and the like of the user PC 2. Then, the created packet is sent out to the administrator PC 1 (Step 208), and the processing ends. In such a way, the encrypted packet including the update request for the wireless LAN profile is created, and sent out from the user PC 2 to the administrator PC 1.

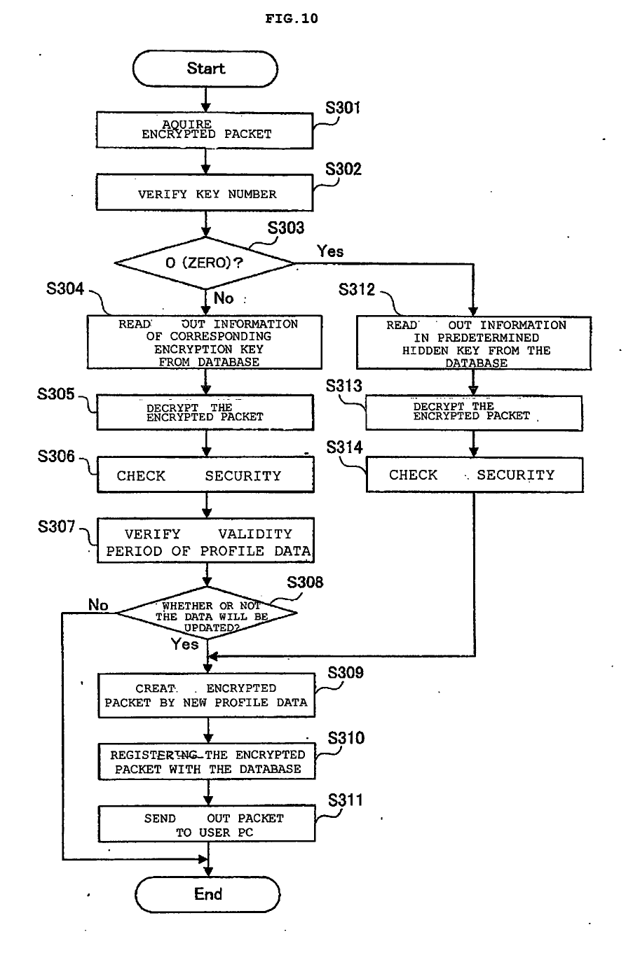

FIG. 10 is a flowchart showing processing executed in the administrator PC 1. The administrator's application 60 acquires the encrypted packet by the profile acquisition/output unit 61 (Step 301). Thereafter, the key number of the profile is verified (Step 302). In this case, it is checked whether or not the key number is set at “0” (zero), and specifically, whether or not the key number is present (Step 303). When the key number is present, in the profile encryption/decryption unit 62, information of an encryption key corresponding to the key number is read out from the management information storage unit 66 that is a database (Step 304), and the encrypted packet is decrypted (Step 305). Thereafter, a security check is performed in the security check unit 63 (Step 306). Then, for example, based on the date and time information included in the profile, the validity period of the profile data is verified (Step 307), and it is verified whether or not the update of the data is necessary (Step 308). When the update of the data is not necessary, the processing ends. When the update of the data is necessary, the processing moves to Step 309.

When the key number is not present in Step 303, in the profile encryption/decryption unit 62, encryption information in a predetermine hidden key is read out from the management information storage unit 66 that is a database (Step 312), and the encrypted packet is decrypted (Step 313). Then, a security check is performed (Step 314), and the processing then moves to Step 309.

In Step 309, an encrypted packet made by new profile data is created in the updated profile creation unit 65 and the profile encryption/decryption unit 62. Then, the encrypted packet is registered with the management information storage unit 66 that is a database (Step 310), and is sent out to the user PC 2 through the profile acquisition/output unit 61, the device driver 51, and the like (Step 311). Then, the processing ends.

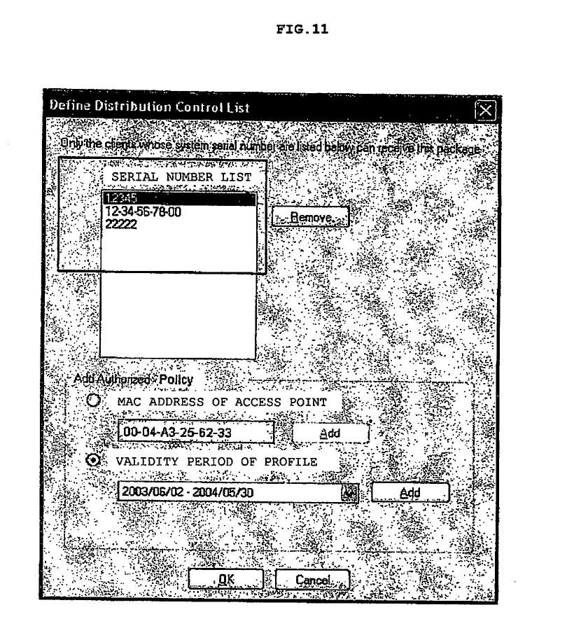

FIG. 11 is an illustration showing an example of a user interface (GUI) displayed on a display (not shown) of the administrator PC 1. Here, as information embedded by an IT administrator utilizing the administrator PC 1, a serial number list, the MAC number of the access point 3, the validity period of the profile and the like are displayed. This displayed content is the content read out from the management information storage unit 66 stored in the hard disk drive 28, and a content entered by the IT administrator. The IT administrator utilizing the administrator PC1 issues instructions for the display as shown in FIG. 11 by use of a pointing device (not shown), a keyboard (not shown) and the like. Thus, it is made possible to distribute the profile to the plurality of user PC present in the wireless LAN environment, to update the profile, and so on.

As mentioned above, it has been necessary for an administrator of the conventional access point 3 to manually set the secure data of the wireless LAN for the respective client computers under the network environment. Meanwhile, even in the case of notifying a hidden WEP key, an administrator of the wireless hotspot has offered a content thereof to the client computers without encrypting a content thereof. This has been a serious problem in terms of a leak of secret. Moreover, conventionally, once the encryption key of the wireless LAN has been set for the client computers, the content thereof has not been able to be updated easily. However, by using the technique described in this embodiment, the administrator PC 1 administering the access point 3 can easily update the encryption key of the access point 3, which is set at the user PCs 2, at any time when desired. This easy update can be performed as long as the access point 3 is connected to the wireless LAN even if the content of the current encryption key set at the user PCs 2 is not known. Moreover, the administrator PC 1 can also prevent the profile from being reused by other devices. This technique can be applied to automatic update of confidential data such as, for example, a BIOS password, for a local computer.

Moreover, in this embodiment, the administrator PC 1 can prevent the secure profile data from being used by persons unauthorized to enter the wireless LAN communication. More specifically, for example, the machine and the model are specified, the validity period, the user ID and the password of the access point and/or hotspot are controlled, and so on, thus making it possible to regulate the use of the profile data. For example, the setting of a validity period makes it possible to validate the profile data only during the period, and to restrict an unauthorized user from performing the wireless communication freely by use of the profile data.

Furthermore, in this embodiment, in the case of updating the profiles of the user PCs 2 that are local computers, it is possible to update the profiles by a remote operation from the administrator PC 1 without engaging the administrator in manual update work. Consequently, the work of the administrator is reduced to a great extent, and for example, it becomes unnecessary to set a hotspot broadband server and a SMB (Server Message Block), thus making it possible to secure safety in a small-scale wireless LAN environment, and to reduce total cost to a great extent.

In the drawings and specifications there has been set forth a preferred embodiment of the invention and, although specific terms are used, the description thus given uses terminology in a generic and descriptive sense only and not for purposes of limitation.

1. Apparatus comprising:
a memory having code stored therein;
a wireless LAN interface in wireless communication with a predetermined access point;
a CPU which is coupled to said memory and said wireless interface and which executes the code stored in said memory, the code executed by the CPU being effective to:
accrue, from an administrative computer which administers the setting of the access point, a profile created in the administrative computer, the profile including security information for wireless communications through the access point;
decipher the profile and judge, based on the profile, whether said apparatus meets conditions designated by the administrative computer; and
setting wireless communications through the access point by use of the profile in response to a judgment that said apparatus meets the conditions.

2. Apparatus according to claim 1 wherein the code executed by said CPU is further effective to:
output an update request for the profile to the administrative computer.

3. Apparatus according to claim 2, wherein
the accrual includes validity period information, and
the code which is effective to output the update request for the profile is code which is based on the validity period information included in the profile.

4. Apparatus according to claim 1, wherein the judgment that the computer apparatus is an apparatus meeting the conditions is made such that identification information inherent in said apparatus and identification information included in the profile coincide with each other as a result of a comparison.

5. Apparatus according to claim 4, wherein the judged identification information is information selected from the group consisting of a machine serial number of said apparatus and a MAC address of said apparatus.

6. Apparatus according to claim 1, wherein the code which judges acquires identification information of the access point by scanning the access point, and judges that said apparatus meets the designated conditions in response to the acquired identification information and identification information included in the profile coinciding with each other as a result of a comparison.

7. Apparatus comprising:
a memory having code stored therein;
a storage medium;
a wireless LAN interface in wireless communication with a predetermined access point;
a CPU which is coupled to said memory, said storage medium, and said wireless interface and which executes the code stored in said memory, the code executed by the CPU being effective to:
read information regarding security of said apparatus from said storage medium;
accrue, from an administrative computer administering a setting of the access point, a profile created in the administrative computer, the profile including security information for the wireless communications;
compare the security information included in the profile and the information read from the storage medium with each other, and perform a setting of the wireless communications by use of the profile in response to the security information and the read information coinciding with each other;
monitor a status in response to the wireless communications being set by use of the profile; and
output an update request for the profile to the administrative computer in response to a judgment that it is necessary to update the profile based on the monitored status.

8. Apparatus according to claim 7, wherein the code which outputs encrypts a profile including date and time information, and outputs the encrypted profile to the computer apparatus of the administrator.

9. Apparatus comprising:
a memory having code stored therein for administering a setting of an access point under a wireless LAN environment;
a wireless LAN interface in wireless communication with a user's computer;
a CPU which is coupled to said memory and said wireless interface and which executes the code stored in said memory, the code executed by the CPU being effective to:
acquire a profile requested to be updated from the user's computer performing wireless communications with said apparatus under the wireless LAN environment;
update the acquired profile; and
output the updated profile to the user's computer.

10. Apparatus according to claim 9, wherein the code which updates performs the update by creating a new profile which includes information selected from the group consisting of information of a new encryption key, information of a validity period, and information of an access point for which an access of the user's computer is authorized.

11. A wireless LAN system, comprising:
an access point that is a connecting point of a network in a wireless LAN environment;
an administrative computer administering a setting of the access point; and
a user's computer for executing wireless LAN communications through the access point;
wherein the user's computer sends out information inherent therein to the administrative computer,
the administrative computer encrypts a profile for executing the wireless LAN communications based on the received inherent information, and sends out the encrypted profile to the user's computer, and
the user's computer decrypts the received profile, and performs a setting of the wireless LAN communications by use of the profile.

12. The wireless LAN system according to claim 11, wherein the user's computer judges, based on the decrypted profile, whether the user's computer itself meets conditions designated by the administrative computer, and performs the setting of the wireless LAN communications in response to judging that the user's computer meets the conditions.

13. The wireless LAN system according to claim 11, wherein the user's computer forms the profile by including information regarding date and time in information of an encryption key for use in the user's computer, the information of the encryption key serving as the inherent information, encrypts the profile by use of the encryption key, and sends out the encrypted profile.

14. The wireless LAN system according to claim 11, wherein the user's computer forms the profile by including information regarding date and time in identification information of the device, the identification information serving as the inherent information, encrypts the profile by a hidden key, and sends out the encrypted profile.

15. A method comprising:
updating a profile including setting information for allowing a computer apparatus to perform wireless LAN communications by:
reading a profile including security information of the computer apparatus from a predetermined storage medium;
creating a profile for an update request by including information regarding an update request for the profile in the profile;
encrypting the profile for the update request by use of the read security information; and
sending out the encrypted profile for the update request to a computer apparatus of an administrator.

16. The method according to claim 15, wherein the created profile for the update request includes information of an encryption key for use, and information regarding date and time.

17. A method comprising:
acquiring a profile including setting information for allowing a computer apparatus to perform wireless LAN communications by:
reading identification information inherent in the computer apparatus from a predetermined storage medium;
creating a profile including information regarding an acquisition request for a new profile together with the identification information;
encrypting the created profile by use of a hidden encryption key; and
sending out the encrypted profile to a computer apparatus of an administrator.

18. The method according to claim 17, wherein said creation of a profile includes information to the effect that the profile does not have an encryption key inherent in the computer apparatus and information relating to the date and time that the profile is sent out.

19. A product comprising:
a computer readable storage medium having program functions stored therein for allowing a user's computer apparatus to perform wireless LAN communications, including:
a function to read information regarding security of the user's computer apparatus from a predetermined storage medium;
a function to acquire a profile including security information for the wireless LAN communications from a computer apparatus of an administrator administering a setting of an access point in the wireless LAN communications, the profile being created in the computer apparatus of the administrator; and
a function to compare the security information included in the acquired profile with the information read from the storage medium, and to perform a setting of the wireless LAN communications by use of the profile in response to both of the information coinciding with each other.

20. The product according to claim 19 wherein the computer readable storage medium further includes:
a function to monitor a status of the profile;
a function to judge whether it is necessary to update the profile based on the monitored status; and
a function to output an update request for the profile to the computer apparatus of the administrator to response to a judgment that it is necessary to update the profile.

21. The product according to claim 20, wherein the function to output an update request for the profile to the computer apparatus of the administrator encrypts the profile including information regarding the update request based on the information read from the storage medium, and outputs the encrypted profile.

22. A product comprising:
a computer readable storage medium having computer readable program functions stored therein for allowing a computer apparatus administering a setting of an access point under a wireless LAN environment, including:
a function to acquire a profile requested to be updated from a user's computer apparatus performing wireless communications with the computer apparatus under the wireless LAN environment;
a function to judge whether update processing is necessary for the acquired profile;
a function to create a new profile in response to the update processing being judged as necessary; and
a function to encrypt and output the created new profile.

23. The product according to claim 22, wherein the newly created profile includes information selected from the group consisting of information of a new encryption key, information of a validity period, and information of an access point for which an access of the user's computer apparatus is authorized.
